(19) United States
(12) Patent Application Publication
(10) Pub. No.: US 2008/0290261 A1
(43) Pub. Date: Nov. 27, 2008

(54) Optical Encoder

(76) Inventor: Steve Doe, Surrey (GB)

Correspondence Address: HARRINGTON & SMITH, PC, 4 RESEARCH DRIVE, Suite 202, SHELTON, CT, 06484-6212, US

(21) Appl. No.: 11/631,199

(22) PCT Filed: Jun. 30, 2004
(86) PCT No.: PCT/FI2004/000404

§ 371 Date: Dec. 29, 2006

(51) Int. Cl. H01J 40/14

(52) U.S. Cl. 250/221

(57) ABSTRACT

The present invention relates to an optical encoder for measuring movement. The optical encoder includes at least one light source for outputting light. Furthermore, the optical encoder includes a movable pattern. Furthermore, the optical encoder includes at least one photodetector for detecting the light reflected off the movable pattern, the movable pattern including regions of varying reflectivity for modulating the light from the at least one light source onto the at least one photodetector in response to movement of the pattern, wherein the at least one photodetector is configured to detect the light in detection instants in regular intervals. The light source may be a pulsed light source outputting light in pulses. Furthermore, user equipment including such an optical encoder and a method for measuring movement are disclosed.

### FIELD OF THE INVENTION

The invention relates to an optical encoder. More particularly, the invention relates to measuring movement by means of an optical encoder.

### BACKGROUND OF THE INVENTION

User equipment (UE), for example a mobile terminal, such as a mobile station (MS), a cellular phone, a personal digital assistant (PDA) or the like, or other terminals, such as a personal computer (PC), or other devices, such as a digital camera, may be used to handle information and/or to access a communication network, for example. One skilled in the art is familiar with the features and operation of typical user equipment. A user may use user equipment for tasks such as for making and receiving phone calls, for receiving and sending data from and to the network and for experiencing multimedia content or otherwise using multimedia services. Furthermore, user equipment may be used for capturing still or video images, recording and outputting voice and so on.

The operation of user equipment may be controlled by means of an appropriate user interface such as control buttons, voice commands and so on. User equipment may be provided with a display for displaying images and other graphical information for the user of the user terminal. Camera means may be provided for capturing still or video images. Speaker means may also be provided. User equipment may include an antenna for wirelessly receiving and transmitting signals from and to base stations of a mobile communication network. Furthermore, a user terminal is typically provided with a processor entity and memory means.

The number of different functions supported by user equipment is increasing. Handling such functions, for example navigation among menu items, selection of menu items and data entry, may be time consuming and difficult by means of control buttons, such as an alphanumerical keypad. Therefore, in some user interfaces a rolling or rotating key has been introduced in addition or to replace control buttons.

A rotating key may use a combination of a code wheel and a photosensor for detecting the amount and direction of the rotation. Two sensors may be used together with an alternating black and white pattern on a surface of the code wheel. The positions of the sensors in relation to the black and white pattern on the surface of the rotating wheel may be arranged so that when one sensor detects either a completely black or a completely white pattern, the other sensor will detect half white and half black pattern. When the photosensor comprising a light source and a photodetector outputs light and detects the pattern continuously, the photosensor may conclude the amount and direction of the rotation. However, continuous detection consumes a lot of power. This may be a problem in various devices, in particular in mobile devices.

### SUMMARY OF THE INVENTION

In accordance with an aspect of the invention, there is provided an optical encoder for measuring movement. The optical encoder comprises at least one light source for outputting light. Furthermore, the optical encoder comprises a movable pattern. Furthermore, the optical encoder comprises at least one photodetector for detecting the light reflected off the movable pattern, the movable pattern comprising regions of varying reflectivity for modulating the light from the at least one light source onto the at least one photodetector in response to movement of the pattern, wherein the at least one photodetector is configured to detect the light at a detection rate comprising detection instants in regular intervals.

In accordance with another aspect of the invention, there is provided user equipment comprising such an optical encoder.

In accordance with a further aspect of the invention, there is provided a method for measuring movement. The method comprises outputting light from at least one light source. Furthermore, the method comprises moving a movable pattern positioned relative to the at least one light source, the pattern comprising regions of varying reflectivity. Furthermore, the method comprises modulating the light from the at least one light source onto a photodetector in response to movement of the pattern. Furthermore, the method comprises detecting the light reflected off the movable pattern in the photodetector at a detection rate comprising detection instants in regular intervals.

In an embodiment, the optical encoder may comprise two sensors each comprising a light source and a photodetector. In an embodiment, the optical encoder may comprise two photodetectors and one light source. A direction of the movement may be determined by comparing the light reflected from the movable pattern in each of two photodetectors during a determined detection instant to the light reflected from the movable pattern during the previous detection instant.

In an embodiment, the light source may comprise at least one pulsed light source for outputting light in pulses. The at least one photodetector may be configured to detect light reflected from the movable pattern during each pulse.

In an embodiment, the at least one photodetector may be connected to processing means for converting the amount of reflected light received in the at least one photodetector in a suitable analogue signal which is proportional to the amount of reflected light.

The movable pattern may comprise regions of low reflectivity and high reflectivity. In an embodiment, the movable pattern may comprise alternating black and white regions. In an embodiment, the regions of low reflectivity may be positioned at a first distance from a light source, the first distance being longer than a second distance between the regions of high reflectivity and said light source.

The movable pattern may be arranged on a surface of a rotary dial. The movable pattern may comprise equally spaced sectors having alternating two different reflectivities. The detection rate may be at least twice the rotational speed of the rotary dial multiplied by a number of sectors in the movable pattern.

In an embodiment, the pattern may be arranged on a stationary surface and the sensor is configured to move in function of the stationary surface.

### BRIEF DESCRIPTION OF THE DRAWINGS

The invention will now be described in further detail, by way of example only, with reference to the following examples and accompanying drawings, in which:

FIG. 1 shows an example of user equipment in which the embodiments of the invention may be implemented;

FIG. 2 shows a principle of an optical encoder;

FIG. 3 shows a principle of determining the direction of rotation of a rotating member using continuous detection;

FIG. 4 shows an example of determining the direction of rotation of a rotating member according to an embodiment of the invention;

FIG. 5 shows an output of a photodetector of an optical encoder in function of a distance;

FIG. 6 shows an embodiment of the invention; and

FIG. 7 shows a further embodiment of the invention.

### DETAILED DESCRIPTION OF PREFERRED EMBODIMENTS

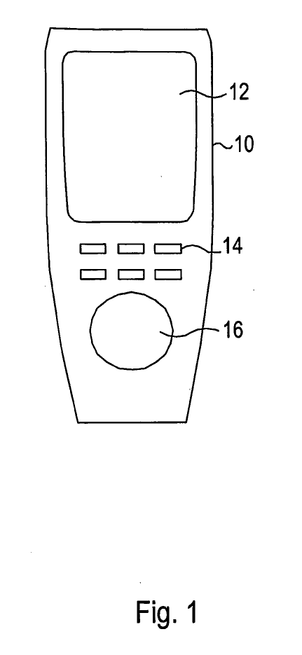

FIG. 1 shows an example of user equipment 10 comprising radio reception and transmission means built in the casing of the user equipment. The user terminal 10 is provided with a display 12 and control buttons 14.

FIG. 1 shows only one exemplifying user equipment having a form of a mobile terminal. It shall be appreciated that the type of the user equipment may differ substantially from what is shown in FIG. 1. The radio reception and transmission means may as well be in a form of a visible antenna extending from the casing of the user equipment. The control buttons may be positioned in an appropriate manner depending on the user equipment type, size and use, for example. The user equipment may be any other user equipment, for example a PDA. Furthermore, in connection with this invention, the term user equipment may also comprise another device comprising a selectable menu, such as a digital camera, even if no reception and transmission means are included.

Furthermore, a rotary dial 16 or a rotating disk is shown in FIG. 1 on the front surface of the user equipment 10, in addition to the control buttons 14. The rotary dial 16 of FIG. 1 is mounted so that its axis is perpendicular to the front surface of the user equipment 10.

It shall be appreciated that the position and size of also the rotary dial 16 are only examples. Depending on the user equipment, the rotary dial 16 may be different in size, may be positioned in a different position on the surface of the user equipment. In an embodiment, the control buttons 14 may be omitted completely from the user equipment 10 and replaced by the rotary dial 16 functions. In an embodiment, the rotary dial may be mounted perpendicular to the front surface of the user equipment sticking out of the side of the user equipment so that the user may move the dial on its circumference.

In an embodiment, the rotary dial 16 may belong to an optical encoder arrangement for translation of movement into an analogue output representation.

In the rear side, i.e. on the surface which is directed towards the inside of the user equipment, the rotary dial 16 has a pattern having regions of varying reflectivity, such as alternating regions of high reflectivity and low reflectivity. The regions of varying reflectivity may comprise sectors of alternating tones of grey, an alternating black and white pattern or sectors of alternating opacities. Any other appropriate regions of varying reflectivity may also be used.

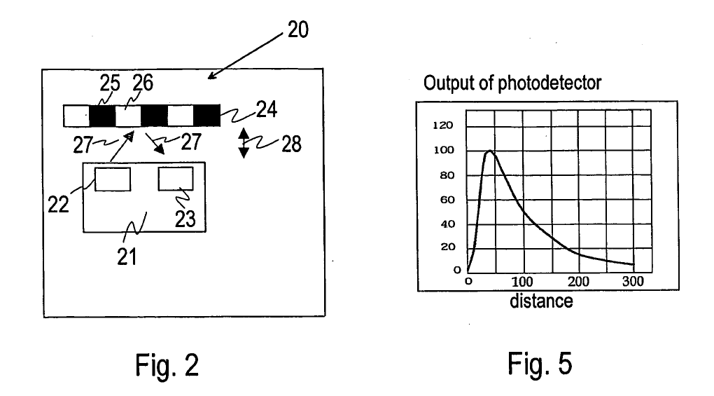

A principle of an optical encoder 20 is shown in FIG. 2 where a sensor 21 comprising a combination of a light source 22, such as an infrared light-emitting diode (IR LED), and a photodetector 23, such as an infrared phototransistor, are used to detect the movement of a movable pattern 24. The movable pattern 24 may be positioned on a surface, such as on the rear side of a moving member, such as a rotary dial. The movable pattern 24 may have alternating low reflectivity portions 25, such as black portions, and high reflectivity portions 26, such as white portions. The light source 22 emits light 27 towards the pattern 24. The emitted light 27 is reflected from the high reflectivity portions 26 of the pattern 24 to the photodetector 23. Little or no light is reflected from the low reflectivity portions 25 of the pattern 24. The photodetector 23 detects whether a high reflectivity or a low reflectivity portion is met based on the amount of the light detected. Appropriate lenses may be included for directing the light from the light source 22 to the photodetector 23.

Two sensors may be used to conclude the direction of the movement of the moving member. Each sensor provides a channel detecting the reflecting light in different phases. Depending on the direction of the movement, one of the channels leads and indicates thus the direction of the movement, such as movement leftwards or rightwards or rotation clockwise or counter clockwise.

For example, the moving member may be a rotating member, such as a rotating dial. In the embodiment comprising two sensors, one of the sensors, the sensor A in FIG. 3, may be used to generate an interrupt to a microcontroller, or similar, as the rotating member is rotated. In FIG. 3, rotation is shown as happening when the pattern goes from a low reflectivity portion to a high reflectivity portion. Then, as shown in FIG. 3, the state of the other sensor, the sensor B in FIG. 3, is used to determine the direction of rotation. For example, in the top of FIG. 3, the output of sensor B is low for the positive edge of the sensor A. This could mean that the direction is clockwise. In the bottom half of FIG. 3, the sensor B output is high for the positive edge of the sensor A. This could mean that the direction is anti-clockwise. For determining the direction of rotation the light source needs to output light continuously, otherwise the edge of the sensor A shall not be present. This may consume a lot of power, for example 10 mA for two IR LEDs as light sources. This is much higher consumption than, for example, standby current of many mobile station displays.

In an embodiment, the optical encoder comprises two photodetectors, but only one light source. Two photodetectors enable to conclude the direction of the movement of the moving member.

In an embodiment, the power consumption may be reduced by outputting light in pulses. In an embodiment, at least one light source, such as an IR LED, is pulse driven, for example, such that at least two measurements are permitted per a sensor cycle, when the moving member is a rotary dial and the movable pattern comprises equally spaced sectors having alternating two different reflectivities. Measuring at a rate of twice the sensor cycle rate may prevent so-called aliasing effects and ensure that a change on light reflectivity is not missed. The sensor cycle rate may be defined as the rotational speed of the rotary dial multiplied by a number of sectors in the movable pattern.

The power consumption may be reduced significantly. For example, repeating a light pulse of 20 μs followed by a switched off period of 20 ms the power consumption may be reduced by a factor of 1000, for example from 10 mA to 10 μA. However, the edge detection scheme described referring to FIG. 3 will not work for determining the direction of rotation when light is output in pulses, as it is unlikely that the sensors will be powered when the alternating high reflectivity and low reflectivity portions on the rotating dial are in a position that would cause an edge.

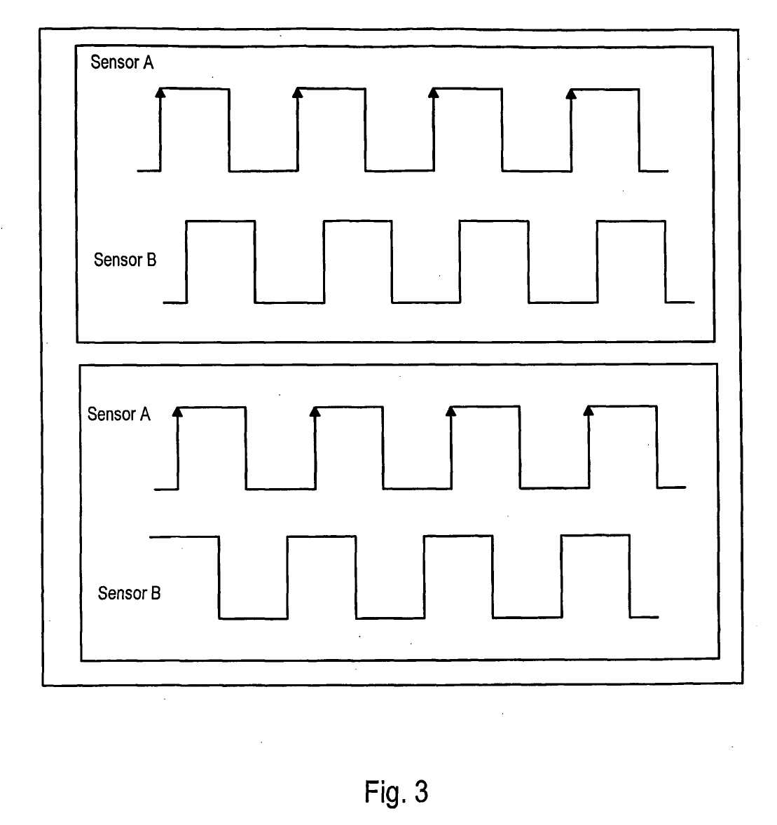

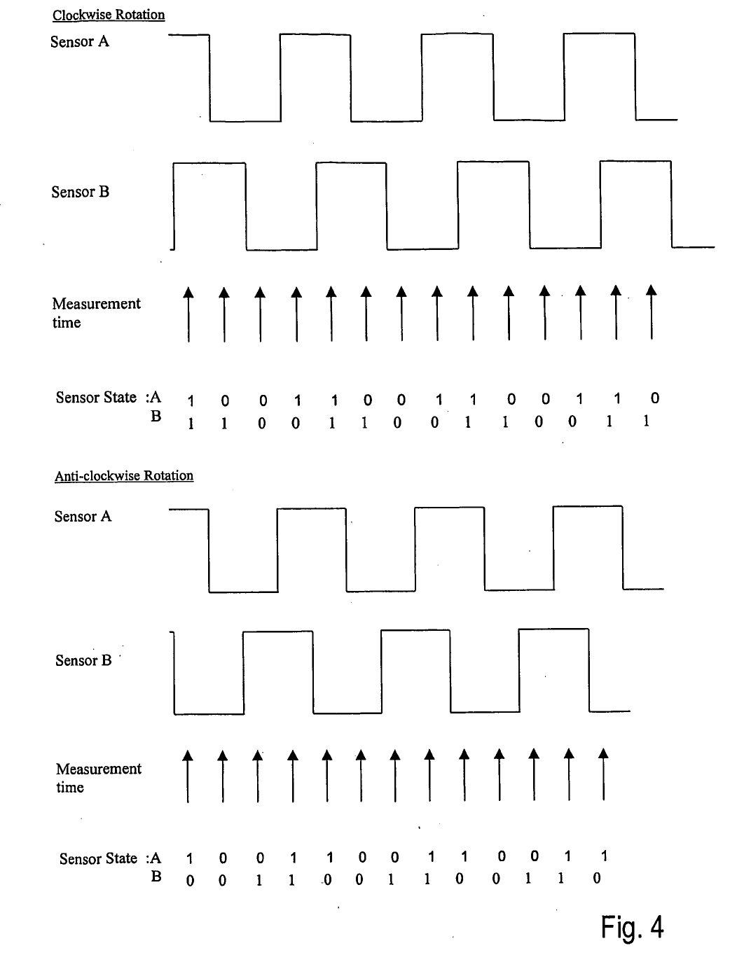

In an embodiment, a standard 4-state encoder may be used to determine direction of movement by detecting the light at a detection rate comprising detection instants in regular intervals. An output from two detectors of the 4-state encoder may be approximately 90 degrees out of phase as shown in FIG. 4. Controlling means, such as a rotator microcontroller may determine the direction of rotation of a rotating member, such as a code disk or a rotary dial. The top half of the FIG. 4 shows the scheme for a clockwise rotation of the rotating member and the bottom half shows the scheme for an anti-clockwise rotation of the rotating member. The state of the two sensors is measured at regular intervals, as indicated by the vertical arrows in FIG. 4. A detection rate may be at least twice the rotational speed of the rotary dial multiplied by a number of sectors in the movable pattern. For example, if rotational speed of the rotary dial is 100 rpm (revolutions per minute) and there are 24 sectors in the movable pattern, the detection rate may be at least 4800 measurements per minute.

In an embodiment, light may be output continuously and the measurement may be carried out by activating detection in the photodetector at predetermined intervals. In an alternative, light may be pulsed as explained above and the measurement may be carried out at the same intervals as the light is pulsed. In a further alternative, the light may be output in pulses and the measurement may be carried out during a pulse, but not necessarily for as long as the pulse lasts and not necessarily during each pulse. The direction of rotation can then be determined by comparing the state of the two sensors with their previous state, as shown in Table 1 referring to FIG. 4.

TABLE 1
Determining the direction of rotation of a rotating member

| Current Sensor | Previous Sensor | |
|---|---|---|
| State (A, B) | State (A, B) | Direction of Rotation |
| 0, 0 | 0, 0 | none |
| | 0, 1 | anti-clockwise |
| | 1, 0 | clockwise |
| | 1, 1 | could be either |
| 0, 1 | 0, 0 | clockwise |
| | 0, 1 | none |
| | 1, 0 | could be either |
| | 1, 1 | anti-clockwise |
| 1, 0 | 0, 0 | anti-clockwise |
| | 0, 1 | could be either |
| | 1, 0 | none |
| | 1, 1 | clockwise |
| 1, 1 | 0, 0 | could be either |
| | 0, 1 | clockwise |
| | 1, 0 | anti-clockwise |
| | 1, 1 | none |

Clockwise and anti-clockwise direction may be determined as indicated in Table 1. In the event of one of the changes defined “could be either” in Table 1, the encoder may assume that the direction of movement remains the same than previously. For example, the encoder knows that the previous movement had been in a clockwise direction. Upon receiving a change of state from 0,0 to 1,1 “could be either”, the encoder would assume the movement was still in a clockwise direction. To verify the assumption, a further detection of state change may be required.

This method gives 48 changes of state for a complete rotation with an exemplifying code disk of 12 black sectors and 12 white sectors. Thus, 48 measurements are needed for each complete rotation, and 48 movements will be detected for each complete rotation. Different numbers of black and white sectors can be used to give a higher or lower number of detected movements for each complete rotation.

Output of the photodetector 23 is a function of the distance 28 from the sensor 21 to the pattern 24 as illustrated in FIG. 5. After a point, when the distance 28 increases the amount of light reflected back from the high reflectivity portion decreases. Some more light may start to reflect from the low reflectivity portions. This reduces the reflected light ratio of the high reflectivity portions to the low reflectivity portions in the photodetector output. External light or electrical noise may change the reflecting characteristics of the high reflectivity and low reflectivity portions of the pattern reducing also the reflected light ratio between the high reflectivity portions and the low reflectivity portions in the photodetector output. Electronic filtering and mechanical design to hinder external light entering in the optical encoder may help in keeping the ratio to an acceptable level.

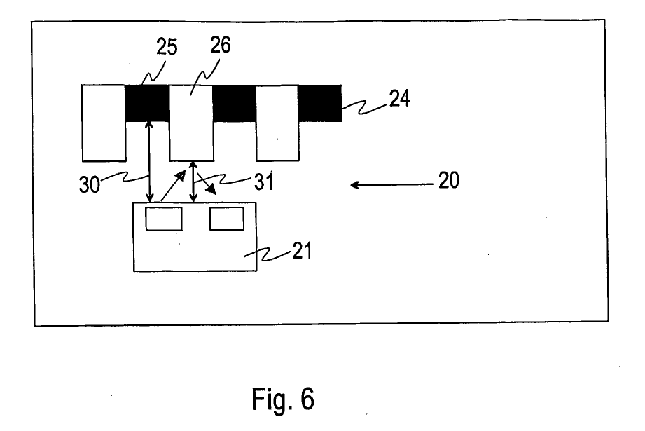

In an embodiment, the reflected light ratio between the high reflectivity portions and the low reflectivity portions may be increased by positioning the low reflectivity portions 25 of the pattern 24 further away from the sensor 21 than the high reflectivity portions 26 of the pattern as shown in FIG. 6. In an embodiment, the low reflectivity portions are positioned at a first distance 30 from the sensor 21, the first distance being longer than a second distance 31 between the high reflectivity portions 26 and the sensor 21.

In an embodiment, the first distance 30 is about twice the second distance 31. For example, the distance 30 between the low reflectivity portions 25 and the sensor 21 may be 200 units and the distance 31 between the high reflectivity portions 26 and the sensor 21 may be 100 units, respectively. For example, in an embodiment using an alternating black and white pattern, this may give a 100% increase in the reflected light ratio between the white portions and the black portions. In an exemplifying embodiment, the first distance may be 1.65 mm nominal, and the second distance may be 0.95 mm nominal. These distances may be suitable, for example, in an optical encoder implemented in a mobile terminal when using an alternating black and white pattern. Other distances and differences between the distances may be used, for example, depending on the user equipment.

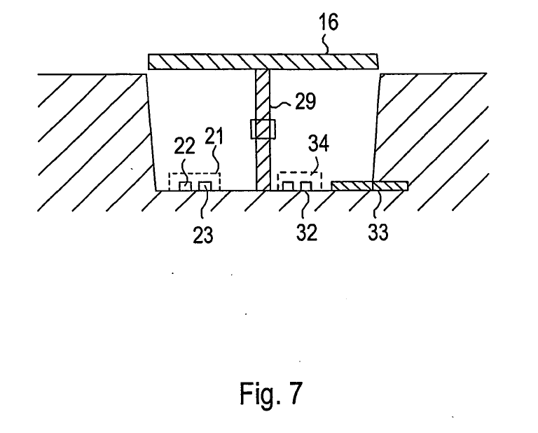

In an embodiment, an arrangement comprising an optical encoder 20 and a rotary dial 16 is implemented in user equipment, such as a mobile station 10 or another type of user equipment. FIG. 7 shows a cross sectional view of the rotary dial 16 mounted perpendicularly on its rotary axis 29 on the user equipment. The rotary axis 29 allows the rotary dial 16 to move freely in clockwise and counter clockwise direction when a rotating force is applied to the rotary dial 16. The rotary axis 29 may be mounted on a printed circuit board (PCB) 32 within the user equipment and may be perpendicular to the PCB 32. The sensor 21 may be mounted on the PCB 32 and positioned below the rotary dial 16 such that the light output from the light source 22 may be reflected from the alternating low reflectivity and high reflectivity pattern on the rear side of the rotary dial 16 and received in the photodetector 23 of the sensor 21.

The sensor 21 may be connected to processing means 33 located in any appropriate location in the user equipment. The processing means 33 may convert the amount of reflected light received in the photodetector 23 in a suitable analogue signal which is proportional to the amount of reflected light. As the rotary dial 16 is rotated, the light is reflected more or less depending on whether a high reflectivity or a low reflectivity portion is met. As explained above, the direction of the movement of the rotary dial 14 is concluded by means of two sensors 21, 34. Information on the movement of the rotary dial 16 may be translated by the processing means 33 or by further processing means into cursor movement on a display of the user equipment, for example, for selecting items from a menu or a character string displayed on the display. The rotary dial 16 may also be moved in a longitudinal direction of its axis 29, for example pressed, for activating a menu function or a character once a portion of the menu or the character has been highlighted by means of the rotary dial 16. This may enable or facilitate, for example, but not limiting to, browsing menus provided by the device or quick text entry using word detection, where text entry can be done by presenting a user with a row of character on the display.

In an embodiment, the optical encoder may utilise a standard commercially available sensor, such as a sensor combining an infrared LED and an infrared phototransistor in one package, which is configured to use a detection rate comprising detection instants in regular intervals and/or the light source may be arranged to output light in pulses in accordance with embodiments of the invention. In further embodiments, other types of light sources may be used, such as a source of visible light outputting light in pulses, depending on the device and its use, for example. The rear side of the rotary dial 16 may be implemented in accordance with embodiments of the invention such that a pattern 24 on the rear side has alternating low reflectivity portions 25 and high reflectivity portions 26 wherein the low reflectivity portions 25 are positioned at a first distance 30 from the sensor 21 or sensors 21, 34, the first distance being longer than a second distance 31 between the high reflectivity portions 26 and the sensor 21 or sensors 21, 34.

In an embodiment, the pattern 24 having alternating low reflectivity portions 25 and high reflectivity portions 26 may lie on a stationary surface and at least one sensor comprising the at least photodetector and the at least one light source is configured to move in function of the stationary surface. For example, the at least one sensor 21 may be positioned on the rear surface of the rotary dial 16 and the pattern 24 may lie on a stationary surface in the user equipment.

Although the invention has been described in the context of particular embodiments, various modifications are possible without departing from the scope and spirit of the invention as defined by the appended claims. It should be appreciated that whilst embodiments of the present invention have mainly been described in relation to mobile terminals, embodiments of the present invention may be applicable to other types of user equipment that may have a selectable menu or another application requiring control means. Furthermore, the optical encoder may comprise an alternating low reflectivity and high reflectivity pattern in another form than the rear side of the rotary dial. As an example, the alternating low reflectivity and high reflectivity pattern may have a rectangular or an elongated form.

1. An optical encoder for measuring movement, the optical encoder comprising:
at least one light source for outputting light,
a movable pattern; and
at least one photodetector for detecting the light reflected off the movable pattern, the movable pattern comprising regions of varying reflectivity for modulating the light from the at least one light source onto the at least one photodetector in response to movement of the pattern, wherein the at least one photodetector is configured to detect the light at a detection rate comprising detection instants in regular intervals.

2. An optical encoder according to claim 1, comprising two sensors each comprising a light source and a photodetector.

3. An optical encoder according to claim 1, comprising two photodetectors and one light source.

4. An optical encoder according to claim 2, wherein a direction of the movement is determined by comparing the light reflected from the movable pattern in each of two photodetectors during a determined detection instant to the light reflected from the movable pattern during the previous detection instant.

5. An optical encoder according to claim 1, wherein the at least one light source comprises at least one pulsed light source for outputting light in pulses.

6. An optical encoder according to claim 5, the at least one photodetector configured to detect light reflected from the movable pattern during each pulse.

7. An optical encoder according to claim 1, wherein the at least one photodetector is connected to processing means for converting the amount of reflected light received in the at least one photodetector in a suitable analogue signal which is proportional to the amount of reflected light.

8. An optical encoder according to claim 1, wherein the movable pattern comprises regions of low reflectivity and high reflectivity.

9. An optical encoder according to claim 8, wherein the movable pattern comprises alternating black and white regions.

10. An optical encoder according to claim 8, wherein the regions of low reflectivity are positioned at a first distance from at least one light source, the first distance being longer than a second distance between the regions of high reflectivity and said at least one light source.

11. An optical encoder according to claim 10, wherein the first distance is about twice the second distance.

12. An optical encoder according to claim 10, wherein the first distance is 1.65 mm and the second distance is 0.95 mm.

13. An optical encoder according to claim 1, wherein the movable pattern is arranged on a surface of a rotary dial.

14. An optical encoder according to claim 13, wherein the movable pattern comprises equally spaced sectors having alternating two different reflectivities.

15. An optical encoder according to claim 14, wherein the detection rate is at least twice the rotational speed of the rotary dial multiplied by a number of sectors in the movable pattern.

16. An optical encoder according to claim 1, wherein the pattern is arranged on a stationary surface and at least one sensor comprising the at least one light source and the at least one photodetector is configured to move in function of the stationary surface.

17. An optical encoder for measuring movement, the optical encoder configured to:
output light from at least one light source;
move a movable pattern positioned relative to the at least one light source, the pattern comprising regions of varying reflectivity;
modulate the light from the at least one light source onto at least one photodetector in response to movement of the pattern; and
detect the light reflected off the movable pattern in the at least one photodetector at a detection rate comprising detection instants in regular intervals.

18. User equipment comprising an optical encoder according to claim 1.

19. User equipment comprising an optical encoder for measuring movement, the optical encoder comprising:
at least one light source for outputting light,
a movable pattern; and
at least one photodetector for detecting the light reflected off the movable pattern, the movable pattern comprising regions of varying reflectivity for modulating the light from the at least one light source onto the at least one photodetector in response to movement of the pattern, wherein the at least one photodetector is configured to detect the light at a detection rate comprising detection instants in regular intervals.

20. User equipment according to claim 18, comprising a mobile terminal.

21. Method for measuring movement, the method comprising:
outputting light from at least one light source;
moving a movable pattern positioned relative to the at least one light source, the pattern comprising regions of varying reflectivity;
modulating the light from the at least one light source onto a photodetector in response to movement of the pattern; and
detecting the light reflected off the movable pattern in the at least one photodetector at a detection rate comprising detection instants in regular intervals.

22. Method according to claim 21, comprising determining a direction of the movement by comparing the light reflected from the movable pattern in two photodetectors during a determined detection instant to the light reflected from the movable pattern during the previous detection instant.

23. Method according to claim 21, wherein the step of outputting the light comprises outputting the light in pulses from at least one pulsed light source.

24. Method according to claim 23, wherein the step of detecting comprises detecting light reflected from the movable pattern during each pulse.

25. Method according to claim 21, comprising converting the amount of reflected light received in the at least one photodetector in a suitable analogue signal which is proportional to the amount of reflected light.

26. Method according to claim 21, wherein the step of moving the movable pattern comprising rotating a rotary dial comprising the movable pattern on a surface thereof.

27. Method according to claim 26, wherein the step of detecting the light comprises detecting the light at the detection rate at least twice the rotational speed of the rotary dial multiplied by a number of equally spaced sectors having alternating two different reflectivities in the movable pattern.
